(19) United States
(12) Patent Application Publication
(10) Pub. No.: US 2018/0368448 A1
(43) Pub. Date: Dec. 27, 2018

(54) PUPPY GROWTH PRODUCT AND METHODS THEREOF

(71) Applicant: Mars, Incorporated, McLean, VA (US)

(72) Inventor: Adrian Hewson-Hughes, Villers Bretonneux (FR)

(73) Assignee: Mars, Incorporated, McLean, VA (US)

(21) Appl. No.: 16/062,165

(22) PCT Filed: Dec. 19, 2016
(86) PCT No.: PCT/IB2016/057784

§ 371 Date: Jun. 14, 2018

(30) Foreign Application Priority Data
Dec. 17, 2015 (GB) 1522300.1

(51) Int. Cl. A23K 50/42; A23K 20/147; A23K 20/158; A23K 50/48; A23K 50/60

(52) U.S. Cl. CPC A23K 50/42; A23K 20/147; A23K 50/60; A23K 50/48; A23K 20/158

(57) ABSTRACT

The present invention relates to a dietary regime comprising a first stage pet foodstuff and a second stage pet foodstuff, wherein the first stage pet foodstuff comprises a ratio of protein:fat of 1:0.67 to 1:0.80 on a gram:gram or a dry matter basis and the second stage pet foodstuff comprises a ratio of protein:fat of 1:0.77 to 1:1.1 on a gram:gram or a dry matter basis for feeding a companion animal, wherein the first stage pet foodstuff is for feeding to a companion animal aged less than 6 months and the second stage pet. The present invention also relates to the use of the foodstuffs in combination to provide health benefits to the companion animal. The present invention also relates to the method of feeding the pet foodstuffs described and/or dietary regimes described to optimise the growth and development of the companion animal and kits comprising the first stage and second stage pet foodstuffs described herein.

The present invention relates to a dietary regime comprising a first stage pet foodstuff and a second stage pet foodstuff, wherein the first stage pet foodstuff comprises a ratio of protein:fat of 1:0.67 to 1:0.80 on a gram:gram or a dry matter basis and the second stage pet foodstuff comprises a ratio of protein:fat of 1:0.77 to 1:1.1 on a gram:gram or a dry matter basis for feeding a companion animal, wherein the first stage pet foodstuff is for feeding to a companion animal aged less than 6 months and the second stage pet. The present invention also relates to the use of the foodstuffs in combination to provide health benefits to the companion animal. The present invention also relates to the method of feeding the pet foodstuffs described and/or dietary regimes described to optimise the growth and development of the companion animal and kits comprising the first stage and second stage pet foodstuffs described herein

In previous research to understand macronutrient intake targets in animals, cats and dogs were provided with a number of foods (typically 3), each containing different amounts of protein, fat and carbohydrate and the animal allowed to self-select a diet composition of its choosing. Using this approach the adult cats and dogs showed to regulate their intake of protein, fat and carbohydrate to achieve an intake target for these macronutrients (Hewson-Hughes et al, 2011, 2013a, 2013b). Such previous studies have shown that adult dogs compose a diet with an average protein to fat ratio (on a gram:gram intake basis) of 1:0.94 (having a 95% confidence interval of about 0.86 to 1.01).

Intake target of macronutrients represents the amounts and balance of nutrients that an animal needs to eat to gain a ‘performance’ benefit (usually measured in terms of growth, survival and reproduction—i.e. evolutionary fitness; Simpson et al, 2004). Evidence from other species indicates that the target intake does not appear to be ‘hardwired’, but will shift over developmental (i.e. lifestage), seasonal and evolutionary timescales, as well as in response to physiological and environmental challenges (Raubenheimer & Simpson, 1997; Simpson & Raubenheimer, 2012).

All dogs, regardless of their breed, grow rapidly during the first few months before slowing to a reduced rate of growth (FIG. 1). The development of puppies can be divided into four distinct stages: neonatal period, transitional period, socialisation period and juvenile period (Scott JP & Fuller JL (1965) Genetics and the social behaviour of the dog. University of Chicago Press). During the neonatal period (birth to 2 weeks of age) the majority of the puppy's time is spent sleeping or eating and they are only able to feed by suckling from the mother. During the transitional period (2 to 3 weeks of age) movement skills improve and lapping and chewing behaviours begin to develop. Weaning may begin as puppies start to show an interest in their mother's food, although all their nutritional requirements continue to be met through the mother's milk. In the socialisation period (3 to 12 weeks of age) puppies develop social skills and learn about their environment. Milk teeth begin to appear and they will increasingly eat solid food. By 4 weeks old (1 month of age) it is essential that puppies are offered food specifically formulated for puppies to supplement the milk they receive from the mother. The mother will begin to discourage suckling and puppies will be fully weaned by 6 to 8 weeks old. By 2 to 3 months, puppies are considered to be in their post weaned stage and therefore their diets can be entirely composed of commercially available puppy food. By the time the juvenile period is reached (12 weeks to adulthood) most major changes have taken place, although puppies are still growing and other physiological changes are occurring. Sexual maturity usually occurs around 6 to 7 months although they are still developing and not considered adults at this stage. The length of the juvenile period varies according to breed size; with toy breeds reaching their adult size around 9 months of age, small and medium sized breeds reach adult size around one year, while large and giant breeds are not considered adult until 18 to 24 months of age.

The nutrient requirements of newborn puppies until about 4 weeks of age are met solely through the milk provided by the mother. Studies have shown that the composition of the milk is relatively high in fat, being of a similar or often greater concentration relative to protein. For example, studies have shown that the milk from lactating bitches contains, on average, 22.7% dry matter, 9.47% fat, 7.53% protein, 3.81% sugar and 146 kcal gross energy per 100 g (a protein to fat ratio of 1:1.26). On average, lactating bitches are known to produce concentrated milk having 8-12% fat and 7-10% protein, thus having a range of protein to fat ratio of 1:0.8 to 1:1.7 (Olav T. Oftedal, Cornell University—“Lactation in the dog: Milk composition and intake by puppies”, J. Nutr. 114: 803-812, 1984).]

It is acknowledged/recognised that puppies have different nutritional requirements to adult dogs. Current consensus positions on animal nutrition such as the guidelines published by the National Research Council (NRC) 2006, provide recommendations for the protein content and fat content of diets for growing puppies. The recommendation for protein distinguishes “between puppies of 4-14 weeks old” and “puppies of 14 weeks and older” while no distinction is made for the recommended fat content. These guidelines state that for puppies between 4 and 14 weeks of age the recommended allowance of protein in the diet should be 225 g/kg dry matter, while a lower dietary protein content of 175 g/kg dry matter is recommended for puppies aged 14 weeks and older. The recommended allowance for fat is 85 g/kg dry matter regardless of the age of the puppy. The ratios of protein to fat based on these recommendations are 1:0.38 and 1:0.49 for puppies below and above 14 weeks old, respectively. Adult dogs are recommended pet food having protein of 100 g/kg dry matter and fat of 55 g/kg dry matter, thus having a protein to fat ratio of 1:0.55.

Commercially available puppy food can be dry or wet and may be labelled “puppy” or “junior”. Dry “puppy/junior” food, for example, comprises typically protein to fat ratios of 1:0.41 to 1:0.65 on a gram:gram as fed or dry matter basis and wet food, for example, comprises typically protein to fat ratios of 1:0.83 to 1:0.94. Puppy/junior foods are formulated to be fed until puppies reach adulthood (i.e. commercially available foods comprise of feeding the puppy/junior with 1 pet food (i.e. 1 stage food) during the growth phase prior to adulthood), which can vary between approximately 9 months for toy breeds, 12 months for small and medium breeds and 18-24 months for large and giant breeds. On reaching adulthood, dogs are switched to “Adult” labelled food and commercially available dry dog foods typically have protein to fat ratios of 1:0.33 to 1:0.67 on a gram:gram as fed or dry matter basis and wet foods have typical ratios of protein to fat of 1:0.52-1:0.93.

While it is acknowledged/recognised that current nutritional guidelines from scientific and industry bodies provide recommendations for dietary levels of protein and fat that are independent of each other, the present inventors have found that animals, in particular dogs, adjust their food intake such that protein and fat are consumed in a particular ratio to each other and that this ratio changes at different stages of development.

Normally, most commercial foods for puppies are intended to be fed from weaning (approx. 4 weeks old) until they reach adulthood (approx. 9-24 months old, depending on size), therefore providing the consumer with a 2 stage dietary regimen (i.e. ‘puppy’ and ‘adult’).

The present invention relates to a dietary regime comprising a first stage pet foodstuff and a second stage pet food stuff, wherein the first stage pet foodstuff comprises a ratio of protein:fat of 1:0.67 to 1:0.80 on a gram:gram as fed or dry matter basis and wherein the second stage pet foodstuff comprises a ratio of protein:fat of 1:0.77 to 1:1.5 on a gram:gram as fed or dry matter basis for feeding a companion animal, wherein the first stage pet foodstuff is for feeding to a companion animal aged less than 6 months and wherein second stage pet foodstuff is for feeding to a companion animal aged more than 5 months.

The first stage pet foodstuff is for feeding to a companion animal aged between 1 and 6 months. The second stage pet foodstuff is for feeding to a companion animal aged between 5 to 18 months.

The first stage pet foodstuff may comprise a ratio of protein:fat of about 1:0.7 on a gram:gram as fed or dry matter basis. The second stage pet foodstuff may comprise a ratio of protein:fat of about 1:0.9 on a gram:gram as fed or dry matter basis.

The dietary regime is for use in optimising growth and development in the companion animal.

The companion animal is a dog. In particular the companion animal may be a large breed dog, optionally a Labrador.

The present invention also relates to a method of optimising growth and development in a companion animal, wherein the companion animal is aged less than 6 months is fed a first stage pet foodstuff and wherein the companion animal is aged more than 5 months is fed a second stage pet foodstuff; wherein the first stage pet foodstuff comprises a ratio of protein:fat of 1:0.67 to 1:0.80 on a gram:gram as fed or dry matter basis and wherein the second stage pet foodstuff comprises ratio of protein:fat of 1:0.77 to 1:10 on a gram:gram as fed or dry matter basis.

The first stage pet foodstuff is for feeding to a companion animal aged between 1 and 6 months. The second stage pet foodstuff is for feeding to a companion animal aged between 5 to 18 months.

The first stage pet foodstuff may comprise a ratio of protein:fat of about 1:0.7 on a gram:gram as fed or dry matter basis. The second stage pet foodstuff may comprise a ratio of protein:fat of about 1:0.9 on a gram:gram as fed or dry matter basis.

The dietary regime is for use in optimising growth and development in the companion animal.

The companion animal is a dog. In particular the companion animal may be a large breed dog, optionally a Labrador.

The present invention further relates to a dietary regime for feeding a companion animal, wherein the companion animal is aged less than 6 months is fed a combination of at least two pet foodstuffs, wherein one pet foodstuff comprises a ratio of protein:fat of 1:0.2 to 1:0.65 and the other pet foodstuff comprises a protein to fat ratio of 1:0.85 to 1:1.5 wherein the combined protein to fat ratio is 1:0.67 to 1:0.80 on a gram:gram as fed or dry matter basis for the first stage pet foodstuff and wherein the companion animal is aged more than 5 months is fed a second stage pet foodstuff comprising a protein to fat ratio of 1:0.77 to 1:10 on a gram:gram as fed or dry matter basis.

The companion animal is a dog. In particular the companion animal may be a large breed dog, optionally a Labrador.

The invention also relates to a kit comprising a first stage pet foodstuff and a second stage pet food stuff, and a package for separately housing the first stage pet foodstuff and the second stage pet foodstuff, wherein the first stage pet foodstuff comprises a ratio of protein:fat of 1:0.67 to 1:0.80 on a gram:gram as fed or dry matter basis and wherein the second stage pet foodstuff comprises a ratio of protein:fat of 1:0.77 to 1:1.5 on a gram:gram as fed or dry matter basis, wherein the first stage pet foodstuff is for feeding to a companion animal aged less than 6 months and wherein second stage pet foodstuff is for feeding to a companion animal aged more than 5 months for optimising growth and development in the companion animal.

The kit may comprise an insert placed in the second stage pet foodstuff compartment including feeding instructions and a purchase incentive and/or further comprise the first stage pet foodstuff is a full size package and the second stage pet foodstuff is a sample size package.

In some embodiments, the pet foodstuff comprises a ratio of protein:fat of 1:0.67 to 1:0.80 on a gram:gram as fed or dry matter basis and is for a companion animal aged less than 6 months.

The pet foodstuff may have a the ratio of protein:fat of about 1:0.7 on a gram:gram as fed or dry matter basis.

The companion animal is aged between 1 and 6 months, preferably the companion animal is a dog. The pet foodstuff having such required protein to fat ratio is for use in optimising growth and development in the companion animal.

In some embodiments, the invention relates to a method of optimising growth and development in a companion animal aged less than 6 months, wherein the companion animal is fed a pet foodstuff comprising a ratio of protein:fat of 1:0.67 to 1:0.80 on a gram:gram as fed or dry matter basis.

The pet foodstuff may have a the ratio of protein:fat of about 1:0.7 on a gram:gram as fed or dry matter basis.

The companion animal is aged between 1 and 6 months, preferably the companion animal is a dog. The pet foodstuff having such required protein to fat ratio is for use in optimising growth and development in the companion animal.

In some embodiments, the invention relates to a dietary regime for feeding a companion animal, wherein the companion animal aged less than 6 months is fed a first stage pet foodstuff and wherein the companion animal aged more than 5 months is fed a second stage pet foodstuff; wherein the first stage pet foodstuff comprises a ratio of protein:fat of 1:0.67 to 1:0.80 on a gram:gram as fed or dry matter basis and wherein the second stage pet foodstuff comprises a ratio of protein:fat of 1:0.77 to 1:1.5 on a gram:gram as fed or dry matter basis.

The first stage pet foodstuff is fed to a companion animal that is aged between 1 and 6 months

The second stage pet foodstuff is fed to a companion animal that is aged more than 5 months, for example aged between 5 to 18 months.

The first stage pet foodstuff may comprise a ratio of protein:fat of about 1:0.7 on a gram:gram as fed or dry matter basis. The second stage pet foodstuff may comprise a ratio of protein:fat of about 1:0.9 on a gram:gram as fed or dry matter basis.

The dietary regime is for use in optimising growth and development in the companion animal. Preferably, when the companion animal is a dog.

In some further aspects, the invention relates to a method of optimising growth and development in a companion animal, wherein the companion animal is aged less than 6 months is fed a first stage pet foodstuff and wherein the companion animal is aged more than 5 months is fed a second stage pet foodstuff; wherein the first stage pet foodstuff comprises a ratio of protein:fat of 1:0.67 to 1:0.80 on a gram:gram as fed or dry matter basis and wherein the second stage pet foodstuff comprises ratio of protein:fat of 1:0.77 to 1:10 on a gram:gram as fed or dry matter basis. In particular, the companion animal is a dog.

The first stage pet foodstuff is fed to a companion animal that is aged between 1 and 6 months

The second stage pet foodstuff is fed to a companion animal that is aged more than 5 months, for example aged between 5 to 18 months.

The first stage pet foodstuff may comprise a ratio of protein:fat of about 1:0.7 on a gram:gram as fed or dry matter basis. The second stage pet foodstuff may comprise a ratio of protein:fat of about 1:0.9 on a gram:gram as fed or dry matter basis.

In yet further embodiments, the invention provides a dietary regime for feeding a companion animal, wherein the companion animal is aged less than 6 months is fed a combination of at least two pet foodstuffs, wherein one pet foodstuff comprises a ratio of protein:fat of 1:0.2 to 1:0.65 and the other pet foodstuff comprises a protein to fat ratio of 1:0.85 to 1:1.5 wherein the combined protein to fat ratio is 1:0.67 to 1:0.80 on a gram:gram as fed or dry matter basis for the first stage pet foodstuff and wherein the companion animal is aged more than 5 months is fed a second stage pet foodstuff comprising a protein to fat ratio of 1:0.77 to 1:10 on a gram:gram as fed or dry matter basis.

The present inventors have demonstrated that a 2 stage dietary regimen is preferred/optimal/required within the puppy period, providing the puppy with a foodstuff having a higher protein to fat ratio than previously shown for a period of time until 6 months of age to ensure the unique physiological demands of this rapid phase of growth and development are optimally met and then switching the food to a foodstuff that comprises a lower protein to fat ratio than previously provided to optimise the slower growth and development phase of older puppies as they transition into adulthood (growth and development stages shown in FIG. 1).

The present inventors have also found that carbohydrate is not necessarily a determining factor in the macronutrient selection process of the animal as concluded in a previous study. The determining nutrients have been found to be protein and fat. In particular, the ratio of protein to fat at different stages of the animal development is important.

The present invention has shown that, in a dietary selection scenario, puppies alter their intake of foods to achieve target intakes for protein and fat. Surprisingly, the inventors of the present invention have found that the ratio of protein to fat of the diet composed by puppies below 6 months of age is different to that of puppies of 6 months and older. This unexpected difference in the self-selected protein to fat ratio indicates that the physiological demands of puppies less than 6 months old are best met by a diet with a particular balance (ratio) of protein and fat and that this should be different to a diet for a puppy of 6 months or older which should have a different protein:fat ratio.

Therefore, the present invention describes a pet foodstuff that comprises a protein to fat ratio which is an optimal intake that a companion animal less than 6 months old would consume to ensure the unique physiological demands of this rapid phase of growth and development are optimally met.

The inventors have unexpectedly discovered that the ratio of protein to fat of the diet composed by puppies below 6 months of age is different to that of puppies of 6 months and older. The ratio of protein to fat selected by puppies less than 6 months old is also surprisingly different to that which would have been previously provided to the puppies in the mother's milk and also different to that based on dietary protein and fat recommendations for puppies in known nutritional guidelines. This novel and unexpected finding is useful for preparing food products (or feeding regimens) in which the protein to fat ratio is tailored to meet the unique nutritional needs of puppies below 6 months of age which are not currently met by existing products.

The first aspect of this invention relates to a dietary regime comprising a first stage pet foodstuff and a second stage pet foodstuff, wherein the first stage pet foodstuff comprises a ratio of protein:fat of 1:0.67 to 1:0.80 on a gram:gram or a dry matter basis and the second stage pet foodstuff comprises a ratio of protein:fat of 1:0.77 to 1:1.1 on a gram:gram or a dry matter basis for feeding a companion animal, wherein the first stage pet foodstuff is for feeding to a companion animal aged less than 6 months and the second stage pet foodstuff is for feeding to a companion animal that is aged 5 months or above

The present invention relates, for all aspects, to any companion animal. In particular, the present invention relates to a companion animal such as a dog or a cat. Preferably the companion animal is a dog, for example a large breed dog, such as a Labrador. In particular, a companion animal that is aged less than 6 months, preferably 1 to 6 months, most preferably 2 to 6 months (puppy growth stage). In some aspects, the companion animal is aged more than 5 months, preferably 5 to 18 months (juvenile growth stage).

The dietary regime of the present invention is composed of a two stage pet foodstuff.

The first stage foodstuff of the dietary regime is a pet foodstuff comprising a ratio of protein to fat of 1:0.67 to 1:0.80 on a gram:gram as fed or dry matter basis. The first stage pet foodstuff is preferably for a companion animal that is aged less than 6 months.

The first stage pet foodstuff can be fed to the companion animal during the last stage of weaning (i.e. at the same time as the companion animal is fed the mother's milk). The first stage pet foodstuff is preferably fed to a companion animal that has been weaned (i.e. the companion animal is fed the first stage pet foodstuff post weaning, without also being fed the mother's milk). The first stage pet foodstuff is for companion animals that are aged between 1 and 6 months most preferably from 2 to 6 months (puppy growth stage).

The first stage pet foodstuff is preferably for a companion animal that is aged less than 6 months (i.e. 1 to 6 months, 2-6 months or 3 to 6 months of age). In particular, the first stage pet foodstuff of the dietary regime of the invention is for companion animals that are aged between 1 and 6 months, most preferably 2 to 6 months (i.e. puppy growth stage).

The present inventors have shown that companion animals aged below 6 months, preferably between 1 to 6 months, more preferably between 2 to 6 months of age, regulate their protein and fat intake. The companion animals showed signs of composing diets, from a selection of foods offered, with particular amounts of macronutrients which resulted in the overall optimal intake of a protein to fat ratio intake that ranges from 1:0.67 to 1:0.80 on a gram:gram as fed or dry matter basis.

The first stage pet foodstuff may comprise a ratio of protein to fat on a gram:gram as fed or dry matter basis that may range from 1:0.67 to 1:0.80, 1:0.68 to 1:0.79, 1:0.69 to 1:0.78, 1:0.70 to 1:0.77, 1:0.71 to 1:0.78, 1:0.72 to 1:0.77, 1:0.73 to 1:0.76, 1:0.74 to 1:0.75 or any combination thereof. The first stage pet foodstuff may comprise a protein to fat ratio that can be selected from 11:0.67, 1:0.68, 1:0.69, 1:0.70, 1:0.71, 1:0.72, 1:0.73, 1:0.74, 1:0.75, 1:0.76, 1:0.77, 1:0.78, 1:0.79, 1:0.80 on a gram:gram as fed or a dry matter basis. Preferably, the first stage pet foodstuff can have a protein to fat ratio of about and/or approximately 1:0.7 on a gram:gram as fed or dry matter basis.

The present invention has shown that companion animals that are less than 6 months of age aim to regulate their protein to fat intake to approximately 1:0.67 to 1:0.80 on a gram:gram as fed or dry matter basis, most preferably about 1:0.7 on a gram:gram as fed or dry matter basis.

The second stage foodstuff of the dietary regime can be any commercially available foodstuff which comprises a ratio of protein:fat of 1:0.77 to 1:1.1 on a gram:gram as fed or dry matter basis.

The second stage pet foodstuff is preferably for a companion animal that is aged more than 5 months (i.e. approximately 5 months or above). In some aspects, the companion animal is aged more than 5 months, preferably 5 to 18 months (juvenile growth stage). In particular, the second stage pet foodstuff of the dietary regime of the invention is for companion animals that are aged between 5 to 18 months, including companion animals that are aged 5 to 18 months, 5 to 12 months, 5 to 9 months and/or any combinations thereof (i.e. until the companion animal reaches adulthood, depending on its breed and size—the companion animal is going through juvenile growth stage).

The second stage pet foodstuff of the dietary regime invention may comprise a ratio of protein to fat on a gram:gram as fed or dry matter basis that may range from 1:0.77 to 1:1.1, 1:0.78 to 1:1.09, 1:0.79 to 1:1.08, 1:0.8 to 1:1.07, 1:0.81 to 1:1.06, 1:0.82 to 1:1.05, 1:0.83 to 1:1.04, 1:0.84 to 1:1.03, 1:0.85 to 1:1.02, 1:0.86 to 1:1.01, 1:0.87 to 1:1.0, 1:0.88 to 1:0.99, 1:0.89 to 1:0.98, 1:0.90 to 1:0.97, 1:0.91 to 1:0.96, 1:0.92 to 1:0.95, 1:0.93 to 1:0.94 or any combination thereof. The second stage pet foodstuff may comprise a ratio of protein to fat on a gram:gram as fed or dry matter basis that can be selected from 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, 1.00, 1.01, 1.02, 1.03, 1.04, 1.05, 1.06, 1.07, 1.08, 1.09 or 1.10. Preferably, the second stage foodstuff has a protein to fat ratio of about and/or approximately 1:0.9 on a gram:gram as fed or dry matter basis.

Further, the present inventors have shown that companion animals aged more than 5 months then switch their ratio of protein to fat intake until they reach adulthood (i.e. approximately 18 months of age). The companion animals have shown that aged 5 months and/or above prefer to select foodstuff which results in a protein to fat ratio of 1:0.77 to 1:1.1 on a gram:gram as fed or dry matter basis.

The present invention has shown that companion animals that are more than 5 months of age aim to regulate their protein to fat intake to about 1:0.9 on a gram:gram as fed or dry matter basis.

The dietary regime of the invention includes feeding the companion animal aged less than 6 months with the first stage pet foodstuff as described, then feeding the companion animal a mixed feed of the first stage pet foodstuff and second stage pet foodstuff when the companion animal is aged between 5 to 7 months and then feeding the companion animal aged more than 5 months with the second stage pet foodstuff as described.

The first stage and second stage pet foodstuff of the dietary regime of the invention can be a nutritionally complete pet food products.

Preferably, the first and second stage pet foodstuffs of the invention are nutritionally balanced food products and/or food supplements, for example a pet product and/or pet supplement. The first and second stage foodstuff may be either in the form of a dry foodstuff and/or in the form of a wet foodstuff and/or a combination of both dry and wet foodstuff for each of the first and second stage pet foodstuff.

The pet foodstuff of the first stage and/or second stage may be provided to the companion animal as a separate wet foodstuff and a dry foodstuff and/or combinations thereof. Each of the wet and dry foodstuffs have a protein:fat ratio above and/or below or within the range 1:0.67 to 1:0.80 on a gram:gram as fed or dry matter basis of the first stage pet foodstuff of the dietary regime and the second stage pet foodstuff may be any commercially available foodstuff which comprises a ratio of protein:fat of 1:0.77 to 1:1.1 on a gram:gram as fed or dry matter basis.

The first stage and/or second stage foodstuffs can be any type which is consumed by the companion animal, such as dry product, semi moist product, wet food product or a liquid and includes any food supplement, snack or treat. This includes standard food products including liquids, as well as pet food snacks (for example, snack bars, pet chew, crunchy treat, cereal bars, snacks, biscuits and sweet products). Provided that the particular protein to fat ratios are achieved in accordance with the invention as described.

The foodstuffs are preferably pet products. Such a product is preferably sold as a product for feeding/administering to a companion animal, in particular a pet cat or a pet dog. In particular, the first stage pet foodstuff is to be consumed by a companion animal that is aged below 6 months. Preferably the first stage pet foodstuff is for consumption by puppies, aged below 6 months. In particular, the second stage pet foodstuff is to be consumed by a companion animal that is aged above 5 months. Preferably the second stage pet foodstuff is for consumption by junior and juveniles companion animals, aged above 5 months.

The content of protein and/or fat in the first stage pet foodstuff can be any measure and/or weight percentage of the pet foodstuff desired, provided that the final ratio of protein to fat is of 1:0.67 to 1:0.80 as fed basis or dry matter basis. The content of protein and/or fat in the second stage pet foodstuff can be any measure and/or weight percentage of the pet foodstuff desired, provided that the final ratio of protein to fat is of 1:0.77 to 1:1.1 as fed basis or dry matter basis.

A typical dry pet foodstuff contains about 10-40% crude protein and about 5-40% fat, the remainder being carbohydrate, including dietary fibre and ash. A typical wet or moist product contains (on a dry matter basis) about 40% fat, 50% protein and the remainder being fibre and ash. The foodstuff may be a dry product (with approximately 5 to approximately 15% moisture), a semi-moist product (with approximately 15 to approximately 70% moisture) or a wet product (with approximately 70 to approximately 90% moisture).

The content of protein and/or fat in the first stage or second stage pet foodstuff described can be any measure and/or weight percentage of the pet foodstuff desired, provided that the final ratio of protein to fat, for example, for the first stage pet foodstuff is of 1:0.67 to 1:0.80 on a gram:gram as fed basis or dry matter basis and the final ratio of protein to fat, for example, for the second stage pet foodstuff is 1:0.77 to 1:1.10 on a gram:gram as fed basis or dry matter basis.

For example, the first stage pet foodstuff may be a wet foodstuff comprising a ratio of protein to fat on a gram:gram as fed ranging from 1:0.67 to 1:0.80, wherein the content of protein is 10 g/100 g as fed basis then the content of fat can be 6.7 g/100 g to 8.0 g/100 as fed basis, most preferably 7 g/100 g as fed basis. For example, the first stage pet foodstuff may be a dry pet foodstuff comprising a ratio of protein to fat on a gram:gram as fed ranging from 1:0.67 to 1:0.80, wherein the protein content is of 32 g/100 g on an as fed basis then the content of fat can be 21.4 g/100 g to 25.6 g/100 g on an as fed basis, most preferably about 22.4 g/100 g as fed basis.

For example, the second stage pet foodstuff may be a wet foodstuff comprising a ratio of protein to fat on a gram:gram as fed ranging from 1:0.77 to 1:1.10, wherein the content of protein is 10 g/100 g as fed basis then the content of fat can be 7.7 g/100 g to 11 g/100 as fed basis, most preferably 9 g/100 g as fed basis. For example, the second stage pet foodstuff may be a dry foodstuff comprising a ratio of protein to fat on a gram:gram as fed ranging from 1:0.77 to 1:1.10, wherein the content of protein is 32 g/100 g on an as fed basis then the content of fat can be 24.6 g/100 g to 35.2 g/100 g on an as fed basis, most preferably about 28.8 g/100 g as fed basis.

The first stage and second stage pet foodstuffs may be provided to the companion animal as a separate wet foodstuff and a dry foodstuff and/or combinations thereof.

Each of the wet and dry foodstuffs have a protein:fat ratio above and/or below or within the range 1:0.67 to 1:0.80 on gram:gram as fed or dry matter basis as described for first stage pet foodstuff or above and/or below or within the range 1:0.77 to 1:1.1 on gram:gram as fed or dry matter basis as described for the second stage pet foodstuff.

The preferred protein:fat ratio of the first and second stage pet foodstuff as described (1:0.67 to 1:0.80 gram:gram as fed or dry matter basis or 1:0.77 to 1:1.1 on gram:gram as fed or dry matter basis, respectively) may be achieved by the consumption of the entirety of each of the wet and the dry foodstuff provided to the companion animal. Alternatively, the protein:fat ratio may be achieved by the companion animal self-selecting the required amounts of each of the wet and dry foodstuffs provided to it.

The foodstuffs may be provided at the same time, to enable the animal to eat both types of foodstuff at the same meal. Alternatively, the wet food, for example, may be provided in the morning and the dry foodstuff may be provided as a separate meal in the afternoon or evening, meaning that in the course of 24 hours, the animal will achieve the particular protein:fat ratio as described herein with respect to either the first stage or the second stage pet foodstuff as described above at their respective life stages.

The remaining components of the foodstuffs are not essential to the invention and typical standard products can be included. The combined ingredients of the foodstuffs provide all of the recommended vitamins and minerals for the particular animal in question (a complete and balanced food).

The foodstuffs are preferably a cooked product. It may incorporate meat or animal derived material (such as beef, chicken, turkey, lamb, fish, blood plasma, marrow bone etc. or one or more thereof). The product alternatively may be meat free (preferably including a meat substitute such as soya, maize gluten or a soya product) in order to provide a protein source. The foodstuffs may contain additional protein sources such as soya protein concentrate, milk proteins, gluten etc. The foodstuffs may also contain a fat source such as one or more of chicken fat, turkey fat, beef fat, duck fat, pork fat, lamb fat, etc, fish oil, sunflower oil, vegetable oil, etc. The foodstuffs may also contain a starch source such as one or more grains (e.g. wheat, corn, rice, oats, barley etc.), or may be starch free.

The foodstuffs may be used alone or may be used in combination with a complete and balanced food which provides all the recommended vitamins and minerals for the dog in questions, for example, as described in National Research Council, 2006, Nutrient Requirements for Dogs and Cats, National Academy Press, Washington D.C. (ISBN:0-309-08628-0); or Association of American Feed Control Officials, Official Publication 2015.

The present invention has shown that companion animals that are below 6 months of age aim to regulate their protein to fat intake to about 1:0.7 on a gram:gram as fed or dry matter basis (i.e. a range of protein to fat intake of 1:0.67 to 1:0.80 on a gram:gram as fed or dry matter basis). Such protein to fat ratio is higher than the protein to fat ratio provided in commercially available dry puppy foods and is lower that the protein to fat ratio provided in commercially available wet puppy foods.

The present invention has shown that puppies that have been weaned or are being weaned and are aged less than 6 months of age (i.e. 1 to 6 months, 2-6 months or 3 to 6 months of age) are capable of selecting a protein to fat intake which when provided has a lower fat intake than the fat intake provided by their mothers' milk composition, but higher than the fat intake recommended at this age (as well as higher fat intake than any commercially available puppy food or food targeted for companion animals that are aged less than 6 months).

The first stage foodstuff as described shows that companion animals aged less than 6 months select the specified protein to fat ratio of 1:0.67 to 1:0.80 on a gram:gram as fed or dry matter basis, in order to meet the physiological demands of the rapid growth phase and aid their optimal growth and development during this stage of their growth phase.

Further, the present inventors have shown that companion animals aged more than 5 months then switch their ratio of protein to fat intake until they reach adulthood. The companion animals have shown that aged 5 months and/or above prefer to select foodstuff which results in a protein to fat ratio of 1:0.77 to 1:1.1 on a gram:gram as fed or dry matter basis.

The present invention has shown that companion animals that are more than 5 months of age aim to regulate their protein to fat intake to about 1:0.9 on a gram:gram as fed or dry matter basis.

The dietary regime of the invention includes feeding the companion animal aged less than 6 months with the first stage pet foodstuff as described, then feeding the companion animal a mixed feed of the first stage pet foodstuff and second stage pet foodstuff when the companion animal is aged between 5 to 7 months and then feeding the companion animal aged more than 5 months with the second stage pet foodstuff as described.

The present inventors have shown that to reach an optimum growth and development in the companion animal, the companion animal is preferably fed a 2 stage diet in accordance with the dietary regime as described herein and above. The dietary regime as described for the first aspect is for use in optimising growth and development in the companion animal, preferably in a dog.

The present invention also includes a dietary regime comprising providing to the companion animal a wet foodstuff and dry foodstuff as the first stage pet foodstuff comprising a protein:fat ratio above and/or below or within the range 1:0.67 to 1:0.80 on a gram:gram as fed or dry matter basis and a second stage pet foodstuff that comprises a protein:fat ratio above and/or below or within the range 1:0.77 to 1:1.1 on a gram:gram as fed or dry matter basis, which when fed to the companion animal achieve the protein to fat ratio desired.

The second aspect of the invention relates to use of the dietary regime to provide health benefits to the companion animal. The first stage pet foodstuff comprises a range of protein to fat intake of 1:0.67 to 1:0.80 on a gram:gram as fed or dry matter basis and is fed to a companion animal aged less than 6 months (i.e. 1 to 6 months, 2-6 months or 3 to 6 months of age) to provide the companion animal the beneficial nutrition for meeting the unique physiological demands of the rapid growth phase and optimising their growth and development into adulthood. In particular, the first stage pet foodstuff has a higher protein to fat ratio to optimise the growth of the companion animal during this time period. Optimising growth in the companion animal is achieving the maximum efficiency in the companion animal's growth and development. Then a second stage pet foodstuff comprising a range of protein to fat intake of 1:0.77 to 1:1.1 on a gram:gram as fed or dry matter basis is fed to a companion animal aged more than 5 months (5 to 18 months, 5 to 12 months, 5 to 9 months and/or any combinations thereof) to provide the companion animal the beneficial nutrition for meeting the unique physiological demands of the juvenile growth phase and optimising their growth and development into adulthood.

Growth and development in a companion animal includes improving and/or maintaining the wellbeing and/or health of the animal and/or improving and/or maintaining the weight of the animal so that the animal receives an optimal nutrition to meet the physiological demands of the animal growth stages to adulthood. FIG. 1 shows that dogs of any breed or size all encounter a rapid growth phase between 3 months up to 6 months of age, thereafter their physiological demands decrease during the juvenile period prior to reaching adulthood and plateau into adulthood. It is known that companion animals of other species also encounter the same rapid growth stages as shown in FIG. 1 for dogs.

The combination of providing a companion animal with the first stage pet foodstuff and the second stage foodstuff at the specified stages of their life's provides the companion animal with the beneficial effect of optimising their growth and development into adulthood.

The present invention also relates to a method of optimising growth and development in a companion animal, wherein the companion animal is fed the dietary regime of the invention as described.

Preferred features of the first aspect of the invention apply as for the second aspect of the invention mutatis mutandis.

In a third aspect, the invention relates to a method of optimising growth and development in a companion animal, wherein the companion animal is aged less than 6 months is fed a first stage pet foodstuff and wherein the companion animal is aged more than 5 months is fed a second stage pet foodstuff; wherein the first stage pet foodstuff comprises a ratio of protein:fat of 1:0.67 to 1:0.80 on a gram:gram as fed or dry matter basis and wherein the second stage pet foodstuff comprises ratio of protein:fat of 1:0.77 to 1:10 on a gram:gram as fed or dry matter basis.

Preferred features of the first or second aspects of the invention apply as for the third aspect of the invention mutatis mutandis.

The fourth aspect of the invention relates to a further dietary regime which includes feeding a companion animal aged less than 6 months with a combination of at least two pet foodstuffs, wherein one pet foodstuff comprises a ratio of protein:fat of 1:0.2 to 1:0.65 and the other pet foodstuff comprises a protein to fat ratio of 1:0.85 to 1:1.5 wherein the combined protein to fat ratio is 1:0.67 to 1:0.80 on a gram:gram as fed or dry matter basis for the first stage pet foodstuff and wherein the companion animal that is aged more than 5 months is fed a second stage pet foodstuff comprising a protein to fat ratio of 1:0.77 to 1:10 on a gram:gram as fed or dry matter basis.

Preferred features of the first, second or third aspects of the invention apply as for the fourth aspect of the invention mutatis mutandis.

The invention also relates to a method of meeting the unique physiological demands of the rapid growth phase and optimising growth and development in a companion animal aged less than 6 months (i.e. 1 to 6 months, 2-6 months or 3 to 6 months of age), wherein the companion animal is fed a first stage pet foodstuff comprising a ratio of protein:fat of 1:0.67 to 1:0.80 on a gram:gram as fed or dry matter basis and is then fed a second stage pet foodstuff comprising a range of protein to fat intake of 1:0.77 to 1:1.1 on a gram:gram as fed or dry matter basis is fed to a companion animal aged more than 5 months (5 to 18 months, 5 to 12 months, 5 to 9 months and/or any combinations thereof).

The present description includes a method for preparing the pet foodstuffs as described. The process for the manufacture of the foodstuffs as described can be made according to any method known in the art.

The content of protein and/or fat in the pet foodstuffs as described (first stage and second stage pet foodstuffs) can be any measure and/or weight percentage of the pet foodstuff desired, provided that the final ratio of protein to fat for example is of 1:0.67 to 1:0.80 as fed basis or dry matter basis for the first stage pet foodstuff and/or 1:0.77 to 1:1.10 as fed basis or dry matter basis for the second stage pet foodstuff.

For example, the first stage pet foodstuff may a wet foodstuff comprising a ratio of protein to fat on a gram:gram as fed ranging from 1:0.67 to 1:0.80, wherein the content of protein is 10 g/100 g as fed basis then the content of fat can be 6.7 g/100 g to 8.0 g/100 as fed basis, most preferably 7 g/100 g as fed basis. For example, the first stage pet foodstuff may a dry pet foodstuff comprising a ratio of protein to fat on a gram:gram as fed ranging from 1:0.67 to 1:0.80, wherein the protein content is of 32 g/100 g on an as fed basis then the content of fat can be 21.4 g/100 g to 25.6 g/100 g on an as fed basis, most preferably about 22.4 g/100 g as fed basis.

For example, the second stage pet foodstuff may be a wet foodstuff comprising a ratio of protein to fat on a gram:gram as fed ranging from 1:0.77 to 1:1.10, wherein the content of protein is 10 g/100 g as fed basis then the content of fat can be 7.7 g/100 g to 11 g/100 as fed basis, most preferably 9 g/100 g as fed basis. For example, the second stage pet foodstuff may be a dry foodstuff comprising a ratio of protein to fat on a gram:gram as fed ranging from 1:0.77 to 1:1.10, wherein the content of protein is 32 g/100 g on an as fed basis then the content of fat can be 24.6 g/100 g to 35.2 g/100 g on an as fed basis, most preferably about 28.8 g/100 g as fed basis.

The fifth aspect of the invention relates to kits comprising the two stage diet comprising the first and second stage pet foodstuffs as described for the dietary regime.

The invention also relates to a kit comprising a first stage pet foodstuff and a second stage pet food stuff, and a package for separately housing the first stage pet foodstuff and the second stage pet foodstuff, wherein the first stage pet foodstuff comprises a ratio of protein:fat of 1:0.67 to 1:0.80 on a gram:gram as fed or dry matter basis and wherein the second stage pet foodstuff comprises a ratio of protein:fat of 1:0.77 to 1:1.5 on a gram:gram as fed or dry matter basis, wherein the first stage pet foodstuff is for feeding to a companion animal aged less than 6 months and wherein second stage pet foodstuff is for feeding to a companion animal aged more than 5 months for optimising growth and development in the companion animal.

The invention also provides a kit comprising a first package comprising a wet foodstuff and second package comprising a dry foodstuff for use in such a dietary regime.

The kit may further comprise an insert placed in the second stage pet foodstuff compartment including feeding instructions and a purchase incentive (such as a coupon).

Alternatively and/or in addition, the first stage pet foodstuff of the kit is a full size package and the second stage pet foodstuff is a sample size package.

Preferred features of the first, second, third or fourth aspects of the invention apply as for the fifth aspect of the invention mutatis mutandis.

### EXAMPLES & FIGURES

The invention will now be further described by way of reference to the following Examples and Figures, which are provided for the purpose of illustration only and are not to be construed as being limiting on the invention.

FIG. 1: Shows the similarity of the rapid and more gradual phases of growth in breeds of dogs representing 3 sizes: Toy/small—(Yorkshire terrier), Medium (Beagle), Large (Labrador).

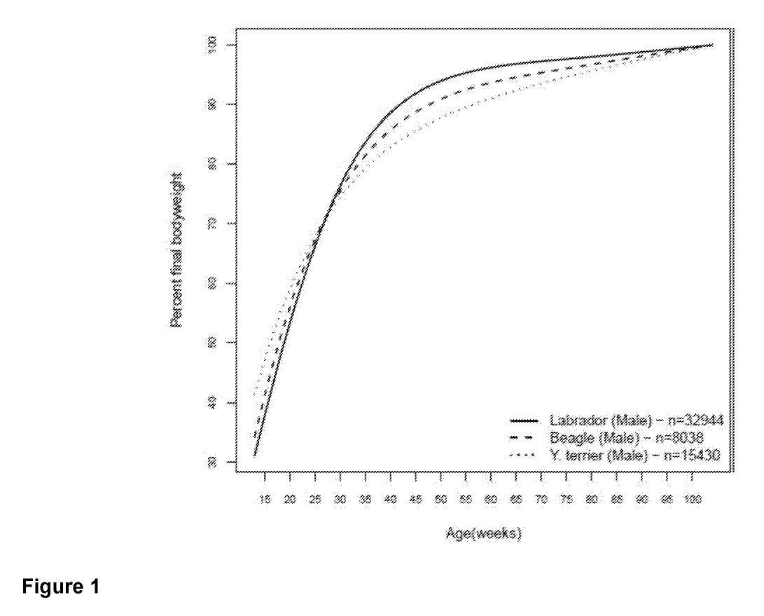

FIG. 2: Nutrient space plots showing mean (with 95% confidence intervals) protein & fat intake (g/kg BWt0.75) of Labrador puppies when (A) provided with a choice of three foods (Food A, Food B, Food C) and (B) when offered one of 3 pairs of foods (B & C, black symbols; B & D, white symbols; B & E, grey symbols). The black lines radiating from the origin represent the protein:fat balance (ratio) of the foods available.

### EXAMPLE 1

Two methods of measuring self-selected diet composition were performed to gain information on whether Labrador puppies select (target selection) and defend (target defence) a particular macronutrient intake as they grow (see below). These methods were performed when the puppies were 3, 6, 9, 12, 15 and 18 months old (target selection) and 4, 7, 10, 13, 16 and 19 months (target defence).

Thirty-six Labrador retriever puppies from five litters born between 30/4/11 and 29/10/11 were entered into the study. Puppies were fully weaned onto a standard wet puppy food (Pedigree® puppy) by 8 weeks of age (i.e. 2 months) and fed this at all times except during the experimental diet selection periods. Puppies were fed individually throughout the study so that the amount of food offered and refused by each puppy could be recorded. Body weight and body condition score (BCS; WALTHAM® S.H.A.P.E.™ guide) were measured weekly from 9 weeks of age and food amounts for individual puppies were adjusted (when not on diet selection phases) with the aim of maintaining puppies at a BCS of D (ideal).

From 8 weeks to 5 months the puppies were fed in three, 30 minute meals per day—08:30 h, 11:30 h and 15:00 h during non-trial feeding and 07:30 h, 11:30 h and 16:00 h during self-selection trial phases (described in more detail below). Between 5 months and 6 months the amount of food offered at the 11:30 meal was gradually reduced so that the puppies were progressively weaned to receive two meals per day from 6 months onwards (i.e. mixed feeding). From 6 months to 19 months the puppies were fed in two 30 minute meals per day—08:30 h and 15:00 h during all phases.

Recipes for 5 wet format foods were designed, using as far as possible the same raw materials. Details of proximate analyses are shown in table 1

TABLE 1
Macronutrient compositions of the foods used in this study.

| | Food | | | | |
|---|---|---|---|---|---|
| Nutrient (g/100 g) | A | B | C | D | E |
| Moisture | 74.5 | 75.1 | 82.8 | 81.4 | 79.8 |
| Protein | 6.2 | 7.4 | 10.7 | 10.3 | 10.0 |
| [g/1000 kcal] | [56.8] | [52.2] | [137.8] | [116.1] | [103.9] |
| Fat | 4.7 | 12.2 | 3.6 | 5.2 | 6.5 |
| [g/1000 kcal] | [43.2] | [86.1] | [46.1] | [59.0] | [68.1] |
| Carbohydrate | 12.0 | 2.5 | 0.9 | 0.8 | 0.7 |
| [g/1000 kcal] | [109.2] | [17.4] | [12.3] | [9.1] | [7.4] |
| Ash | 2.0 | 2.3 | 1.8 | 1.9 | 2.1 |
| Crude Fibre | 0.4 | 0.5 | 0.2 | 0.4 | 0.8 |
| PME* (kcal/100 g) | 108.3 | 140.6 | 74.3 | 86.7 | 93.6 |
| Protein to Fat ratio | 1:0.76 | 1:1.65 | 1:0.34 | 1:0.51 | 1:0.65 |

The values in square brackets [ ] for protein, fat and carbohydrate (nitrogen free extract, NFE) are g/1000 kcal.
*The predicted metabolisable energy (PME) content is shown using the NRC 2006 equation.

Experimental Details

Target Selection—3 Food Choice

The two most important requirements to determine the macronutrient intake target of an animal are:
1. the foods offered to the animal encompass the likely intake target and
2. the foods are offered in excess of the animals energy requirements so that its diet selection is not restricted by food availability.

In order to encompass the likely intake target three wet diets were manufactured that were enriched with either protein (Food C), fat (Food B) or carbohydrate (Food A) relative to each other (Table 1).

Monadic (Learning) Phase

This phase allowed energy intake to be controlled to prevent excess food intake (and excess weight gain) whilst allowing the puppies to gain experience of the nutritional composition of each of the foods separately. Beginning at 10 weeks of age, the puppies were cycled through five, 3-day periods of monadic feeding where they were confined to one of the 3 foods on each of the 3 days. Each day the amount of food to be offered at each meal was split across 3 bowls to accustom the puppies to receiving 3 bowls of food ready for the following self-selection phase.

Self-Selection Phase

Following the 15 day monadic feeding phase the puppies underwent a 6 day self-selection (SS) period where they were offered the 3 foods simultaneously (each in a separate bowl) in order to self-select a diet composition. The bowls were placed in a metal holder so they could not move about as the puppies ate and the position in which the foods were placed in front of the puppies was rotated daily to avoid positional bias. The initial amount of each food to be offered each day was calculated as 200% of maintenance energy requirement (MER) for each individual dog based on the NRC (2006) equation (Table 2). The offering was split across three (at 3 months) or two (6 months and older) 30 minute meals. If all of one (or more) foods was eaten at a meal then the amount of that food(s) was increased for subsequent meals.

Throughout the study, these 3 food choice SS phases were carried out every 3 months following 15 days of monadic feeding (i.e. SS at 3, 6, 9, 12, 15 & 18 months). This approach, of providing the puppies with 3 nutritionally complementary foods (i.e. foods anticipated to span the potential intake target) and allowing them to navigate to their preferred macronutrient intake provided a measure of the intake target selected by the puppies.

Following each 3 diet self-selection (target selection) phase the puppies transferred back to Pedigree® puppy food for ˜2 weeks before undergoing the target defence phase.

TABLE 2
Estimated metabolisable energy (ME) requirements for puppies after
weaning (NRC 2006)
ME (kcal) = 130 × BWₐ^{0.75} × 3.2 × [e^{(-0.87p)} − 0.1]
Where: p = BWₐ/BWₘ BWₐ = actual bodyweight at time of evaluation (kg) BWₘ = expected mature body weight (kg) e = base of natural log ≈ 2.718

Target Defence—Food Pair Choices

It is important to demonstrate that the macronutrient intake achieved by an animal is the result of active regulation and not the result of factors such as random selection across the food offered or due to physical or hedonic properties of the foods. One way to do this is to test whether an animal selects the same position in nutrient space (i.e. ‘defends’ a particular macronutrient intake) when provided with different combinations of nutritionally complementary foods (Raubenheimer & Simpson, 1997; Simpson & Raubenheimer, 2012). We used this approach to determine whether Labrador puppies would select the same macronutrient intake regardless of the food combinations offered. This would demonstrate that the selected intakes reflected active regulation of macronutrient intake whilst different macronutrient intakes according to different food combinations would indicate active regulation was not occurring.

The puppies were assigned to one of three food combinations (food pairs) with n=12 per food pair—B vs. C, B vs. D and B vs. E (see Table 1).

Monadic (Learning) Phase

The puppies were cycled through five, 2-day periods of monadic feeding where they were confined to one of the 2 foods on each of the 2 days. Each day the amount of food to be offered was split across 2 bowls to accustom the puppies to receiving 2 bowls of food ready for the following SS phase.

Self-Selection Phase

Following the 10 day monadic feeding phase the puppies underwent a 4 day SS period where they were offered 2 foods simultaneously (each in a separate bowl) in order to self-select a diet composition. The bowls were placed in a metal holder so they could not move about as the puppies ate and the position in which the foods were placed in front of the puppies was rotated daily to avoid positional bias). The amount of each food offered each day was calculated as 225% of MER based on the NRC (2006) equation (Table 2), split across three (at 4 months) or two (7 months and older) 30 minute meals. If all of one (or more) foods was eaten at a meal then the amount of that food(s) was increased for subsequent meals.

Throughout the study, these food pair choice SS phases were carried out every 3 months following 10 days of monadic feeding (i.e. SS at 4, 7, 10, 13, 16 & 19 months).

Statistical Analyses

Target Selection—3 Diet Choice

The intake of protein, fat and carbohydrate (g/kg metabolic bodyweight) were analysed univariately by linear mixed models and were log₁₀ transformed before analyses due to increasing variation with increasing intake.
Time nested in dog nested in litter was used as the random effects, to allow for the correlation of repeated measures over time within a dog within a litter, fitted with an autoregressive correlation structure of order 1.
Time (months) was included in the model as a fixed effect.
Testing for a change in average over time was performed post-hoc, if an overall significant time effect is seen. These results are presented as a homogenous groups table, compared by Tukey HSD tests at the 5% significance level.
Means and differences between means are reported with 95% family wise confidence intervals (back transformed where necessary).

Target Defence—Food Pair Choices

The intake of protein and fat (g/kg metabolic bodyweight) were analysed univariately by linear mixed models and. were log₁₀ transformed before analyses due to increasing variation with increasing intake.
Time nested in dog nested in litter was used as the random effects, to allow for the correlation of repeated measures over time within a dog within a litter, fitted with an autoregressive correlation structure of order 1.
The residual variance was also weighted by diet choice (due to increasing variability with difference in protein content between diet choices).
Time (months), ‘diet choice’ and their interactions were included in the model as fixed effects.
Testing for a change in percentage energy over time with ‘diet choice comparison’ was performed post-hoc, if an overall significant interaction effect was seen. Changes within diet choice over time and between diet choices within each time were calculated with 95% family wise intervals.
Means and differences between means are reported with 95% family wise confidence intervals (back transformed where necessary).

Results

This is the first research to investigate whether puppies are able to regulate their macronutrient intake. Using two approaches (i.e. 3 food choice and food pair choices) we have demonstrated that (1) puppies regulate their macronutrient intake, in particular the ratio of protein:fat consumed, (2) the ratio of protein to fat intake is consistent across puppies of the same age and (3) the ratio of protein to fat intake changes during development.

Target Selection—3 Food Choice

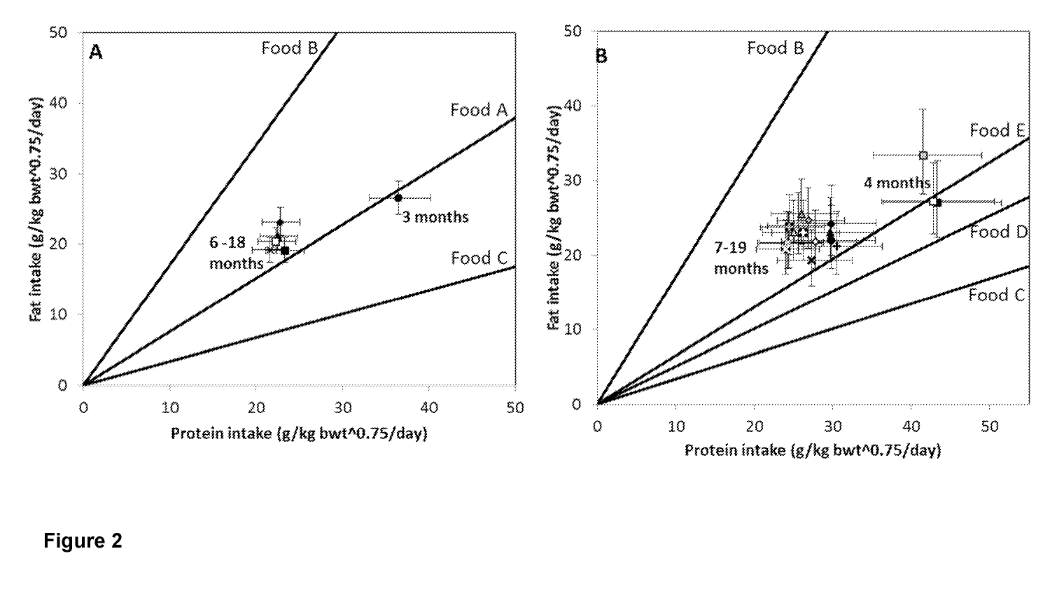

To account for the changes in bodyweight as the puppies grew the macronutrient intakes were analysed in terms of grams eaten/kg metabolic bodyweight (g/kg BWt^{0.75}). A significant effect of time was seen for protein (p<0.0001) and fat (p<0.0001) intake but not for carbohydrate intake (p=0.6661). The average intakes of protein and fat were significantly greater for puppies at 3 months compared to older puppies (Tables 3 & 4, FIG. 2A) whereas carbohydrate intake was not significantly different at any time-point (Table 5).

TABLE 3
Protein intake (g/kg BWt^{0.75}) by Time: means, 95% confidence
intervals + Tukey HSD Homogeneous groups at 5% (groups sharing
the same letter are not significantly different).

| | Protein | | | |
|---|---|---|---|---|
| Time | (g/kg BWt^{0.75}) | 95% Confidence Interval | | Tukey |
| (months) | Mean | Lower | Upper | Groups |
| 3 | 36.5 | 33.1 | 40.2 | b |
| 6 | 23.3 | 21.1 | 25.6 | a |
| 9 | 22.8 | 20.7 | 25.1 | a |
| 12 | 22.5 | 20.5 | 24.8 | a |
| 15 | 21.6 | 19.6 | 23.8 | a |
| 18 | 22.3 | 20.2 | 24.6 | a |

TABLE 4
Fat intake (g/kg MBWt^{0.75}) by Time: means, 95% confidence
intervals + Tukey HSD Homogeneous groups at 5% (groups sharing
the same letter are not significantly different).

| | Fat | | | |
|---|---|---|---|---|
| Time | (g/kg MBWt^{0.75}) | 95% Confidence Interval | | Tukey |
| (months) | Mean | Lower | Upper | Groups |
| 3 | 26.5 | 24.2 | 29.0 | c |
| 6 | 19.1 | 17.5 | 20.9 | a |
| 9 | 23.1 | 21.2 | 25.2 | b |
| 12 | 21.1 | 19.3 | 23.1 | ab |
| 15 | 19.2 | 17.5 | 20.9 | a |
| 18 | 20.4 | 18.7 | 22.3 | a |

TABLE 5
Protein to fat ratios by Time and 95% confidence intervals (combined
results of Tables 3 and 4)

| Time | Protein to | 95% Confidence Interval | | Range and |
|---|---|---|---|---|
| (months) | Fat ratio | Lower | Upper | Life stage |
| 3 | 1:0.726 | 1:0.731 | 1:0.721 | Less than 6 month |
| 6 | 1:0.820 | 1:0.829 | 1:0.816 | 1:0.67 to 1:0.80 |
| 9 | 1:1.013 | 1:1.024 | 1:1.004 | Above 5 months |
| 12 | 1:0.937 | 1:0.941 | 1:0.931 | 1:0.77 to 1:1.15 |
| 15 | 1:0.888 | 1:0.893 | 1:0.874 | |
| 18 | 1:0.915 | 1:0926 | 1:0.907 | |

TABLE 6
CHO intake (g/kg MBWt^{0.75}) by Time: means, 95% confidence
intervals + Tukey HSD Homogeneous groups at 5% (groups sharing
the same letter are not significantly different).

| | CHO | | | |
|---|---|---|---|---|
| Time | (g/kg MBWt^{0.75}) | 95% Confidence Interval | | Tukey |
| (months) | Mean | Lower | Upper | Groups |
| 3 | 14.7 | 11.5 | 18.9 | a |
| 6 | 14.2 | 11.1 | 18.2 | a |
| 9 | 15.1 | 11.8 | 19.3 | a |
| 12 | 16.0 | 12.5 | 20.5 | a |
| 15 | 15.4 | 12.1 | 19.8 | a |
| 18 | 15.7 | 12.3 | 20.2 | a |

Target Defence—Food Pair Choices

Similar to the 3 food choice results, there was a significant change in protein (p<0.0001) and fat (p=0.0001) intake over time with average intakes of protein and fat significantly greater for puppies at 4 months compared to older puppies and then very consistent protein and fat intakes from 7-19 months (FIG. 2B).

Planned contrasts were performed (with adjustments to maintain a family wise error rate of 5%) within time point between diet choices and between time points within diet choices. Within each diet-pair choice protein intake (g/kg BWt^{0.75}) was significantly greater in 4 month old puppies compared to older puppies. Fat intake was significantly greater in 4 month old puppies compared to all later time-points when offered diet pair B vs E and different at 13 and 16 months compared to 4 months for diet pairs B vs C and B vs D. As can be seen in FIGS. 2A and 2B, puppies had very similar protein and fat intakes (adjusted for bodyweight) regardless of whether they were offered a choice of 3 foods (FIG. 2A) or one of 3 different pairs of foods (FIG. 2B). It is also apparent from this figure that fat intake and particularly protein intake was greater in younger puppies (i.e. at 3 & 4 months) compared to older puppies and that protein and fat intake was extremely consistent from 6 months onwards. This provides strong evidence that this change in the puppies' balance of protein to fat intake is to meet changing nutritional requirements with their advancing age and developmental needs.

Ratio of Protein to Fat Intake (q:g)

There was a significant change in the Protein to Fat intake ratio over time, p<0.0001.

The average protein to fat intake ratio at 3 months (1:0.76) was significantly different (relatively lower in fat and higher in protein) compared to all subsequent time points (expressed as F/P in Table 7).

TABLE 7
Fat to Protein (g/g) by Time means, 95% confidence intervals + Tukey
HSD Homogeneous groups at 5% (groups sharing the same letter are
not significantly different).

| Time | Fat to Protein | 95% Confidence Interval | | Tukey |
|---|---|---|---|---|
| (months) | ratio (g/g) Mean | Lower | Upper | Groups |
| 3 | 0.76 | 0.69 | 0.84 | d |
| 6 | 0.85 | 0.77 | 0.92 | a |
| 9 | 1.03 | 0.95 | 1.10 | b |
| 12 | 0.96 | 0.88 | 1.04 | bc |
| 15 | 0.91 | 0.83 | 0.99 | ac |
| 18 | 0.94 | 0.86 | 1.01 | c |

### EXAMPLE 2

To follow up the unexpected finding of a higher protein to fat intake ratio in young (<6 months) Labrador puppies we investigated whether this was consistent in puppies representing different size breeds, namely Yorkshire terrier (toy) and Petit Basset Griffon Vendeen (medium).

Using the 3 food choice (target selection) approach as detailed in example 1, a choice of 3 foods (Table 7) were offered 3 times per day (07:30-07:50 h, 11:30-11:50 h and 15:00-15:20 h) for 6 consecutive days to Yorkshire terrier puppies (n=8) and Petit Basset Griffon Vendeen (PBGV) puppies (n=11) at 3 months of age.

TABLE 8
Macronutrient compositions of the foods used

| | Protein | Fat g/100 g | Carbohydrate |
|---|---|---|---|
| Diet | g/100 g diet | diet | g/100 g diet |
| A | 5.8 | 6.1 | 8.7 |
| B | 6.8 | 11.3 | 2.6 |
| C | 11.3 | 4.7 | 2.2 |

The protein and fat intakes (g/kg BWt^{0.75}) of the 3 month old YT and PBGV puppies are shown in Tables 9 and 10 together with the values from 3 month old Labrador puppies from Example 1. The intakes of protein and fat were very similar in the PBGV and Labrador puppies which were both greater than seen in the YT puppies. However, as can be seen in Table 11 the ratio of protein to fat intake (expressed as F/P in Table ZZ) was consistent across the 3 breeds. This indicates that our initial unexpected finding of a particular ratio of protein to fat intake in Labrador puppies below 6 months of age is more broadly applicable to puppies of less than 6 months of age of other size breeds.

TABLE 9
Mean protein intake (g/kg BWt^{0.75}) + 95% confidence intervals of
Yorkshire terrier (YT), Petit Bassett Griffon Vendeen (PBGV) and
Labrador puppies at 3 months old

| | |
|---|---|
| Protein | |
| (g/kg BWt^{0.75}) | 95% Confidence Interval |

| Breed | Mean | Lower | Upper |
|---|---|---|---|
| YT | 25.0 | 21.1 | 29.6 |
| PBGV | 37.1 | 31.7 | 43.5 |
| Labrador | 36.5 | 33.1 | 40.2 |

TABLE 10
Mean fat intake (g/kg BWt^{0.75}) + 95% confidence intervals of
Yorkshire terrier (YT), Petit Bassett Griffon Vendeen (PBGV) and
Labrador puppies at 3 months old

| | |
|---|---|
| Fat | |
| (g/kg BWt^{0.75}) | 95% Confidence Interval |

| Breed | Mean | Lower | Upper |
|---|---|---|---|
| YT | 18.0 | 15.8 | 20.6 |
| PBGV | 29.1 | 24.4 | 34.7 |
| Labrador | 26.5 | 24.2 | 29.0 |

TABLE 11
Mean ratio of protein to fat intake (expressed as Fat/Protein) with 95%
confidence intervals of Yorkshire terrier (YT), Petit Bassett Griffon
Vendeen (PBGV) and Labrador puppies at 3 months old

| | |
|---|---|
| Fat/Protein | 95% Confidence Interval |

| Breed | Mean | Lower | Upper |
|---|---|---|---|
| YT | 0.74 | 0.57 | 0.95 |
| PBGV | 0.78 | 0.67 | 0.92 |
| Labrador | 0.76 | 0.69 | 0.84 |

### DISCUSSION

The studies found that (1) the protein:fat intake ratio was consistent in three breeds of puppies of the same age (3 months) indicating that this ratio represents a preferred/ideal balance for puppies of different sizes and (2) the balance of protein:fat intake changed with age indicating that macronutrient intake is responsive to the physiological demands of a growing puppy. In particular, the balance of protein:fat intake was strongly regulated during development with young puppies (<6 months) having a higher protein intake than older puppies (adjusted for differences in bodyweight) which may reflect a requirement for extra protein during this period of rapid growth. In puppies between 6 and 19 months, the amount of fat consumed relative to protein was greater compared to younger puppies.

The dietary self-selection approaches used demonstrated that puppies regulated their balance of protein:fat (P:F) intake and that this changed during development. Puppies <6 months had a higher protein intake than older puppies (adjusted for differences in bodyweight) and protein and fat intake were extremely consistent from 6 months onwards (when adjusted for bodyweight). Below 6 months of age, Labrador, Yorkshire Terrier and Petit Basset Griffon Vendeen puppies adjusted their food intake such that protein and fat were consumed in a particular ratio to each other (i.e. they ‘targeted’ a P:F intake ratio of ˜1:0.7), while in Labrador puppies between 6 and 18 months the amount of fat consumed relative to protein increased resulting in a P:F intake ratio of ˜1:0.9.

The results demonstrate that the physiological demands of puppies less than 6 months old are best met by a diet with a particular balance (ratio) of protein and fat and that this should be different to a diet for a puppy of 6 months or older which should have a different protein:fat ratio. The benefits of the 2 stage dietary regimen of the invention is that the first stage provides the preferred/optimal/balance of protein to fat for a period of time until 6 months of age to ensure the unique physiological demands of this rapid phase of growth and development are optimally met. Subsequently, following transfer to a second stage foodstuff that comprises a lower protein to fat ratio than previously provided ensures the optimal balance of protein:fat is provided during the slower growth and development phase of older puppies as they transition into adulthood.

1-15. (canceled)

16. A dietary regime for feeding a companion animal, wherein when the companion animal is aged less than 6 months the companion animal is fed a combination of at least two pet foodstuffs, wherein one pet foodstuff comprises a ratio of protein:fat of 1:0.2 to 1:0.65 and the other pet foodstuff comprises a protein to fat ratio of 1:0.85 to 1:1.5 wherein the combined protein to fat ratio is 1:0.67 to 1:0.80 on a gram:gram as fed or dry matter basis for the first stage pet foodstuff and wherein when the companion animal is aged more than 5 months the companion animal is fed a second stage pet foodstuff comprising a protein to fat ratio of 1:0.77 to 1:10 on a gram:gram as fed or dry matter basis.

17. The dietary regime of claim 16, wherein the companion animal is a dog.

18-20. (canceled)

21. The dietary regime of claim 17, wherein the dog is a large breed dog.

22. The dietary regime of claim 16, wherein the combined protein to fat ratio of the first stage pet foodstuff is about 1:0.7 on a gram:gram as fed or dry matter basis.

23. The dietary regime of claim 16, wherein the second stage pet foodstuff comprises a ratio of protein:fat of about 1:0.9 on a gram:gram as fed or dry matter basis.

24. The dietary regime of claim 16, wherein first stage pet foodstuff is fed to a companion animal aged between 1 and 6 months.

25. The dietary regime of claim 16, wherein the second stage pet foodstuff is fed to a companion animal aged between 5 to 18 months.
